(19) United States
(12) Patent Application Publication
(10) Pub. No.: US 2020/0401024 A1
(43) Pub. Date: Dec. 24, 2020

(54) Active optical rotator and optical system for LCD projector

(71) Applicant: NANHUA INTELLIGENT PRECISION MACHINE (SHENZHEN) CO., LTD., Shenzhen (CN)

(72) Inventor: Hanwen Guo, Wuxi (CN)

(73) Assignee: NANHUA INTELLIGENT PRECISION MACHINE (SHENZHEN) CO., LTD.

(21) Appl. No.: 16/997,959

(22) Filed: Aug. 20, 2020

(30) Foreign Application Priority Data
Apr. 27, 2020 (CN) 2020103424970

(51) Int. Cl. G03B 21/00; G02F 1/1337; G02F 1/133; G03B 21/14

(52) U.S. Cl. CPC G03B 21/006; G03B 21/14; G02F 1/13306; G02F 1/1337

(57) ABSTRACT

An active optical rotator is provided, which includes a first glass substrate, a liquid crystal cell, a liner frame, a second glass substrate, a first connection line and a second connection line. The external driving device drives the liquid crystal cell to rotate the light, so that the illuminating light of the projector optical system with the polarization conversion device is capable of achieving polarization conversion with more efficient and wider wavelength range. Compared with the passive optical rotator, the active optical rotator has a lower price, better performance, better innovation, cost performance and application. An optical system for the LCD projector is further provided, including an LED light source, a transflective plate, a square cone condenser, collimating lens, an active rotator, a brightness-increasing polarizer, an LCD light valve, field lens, reflector and projection lens which are arranged in sequence according to the direction of light travel.

### CROSS REFERENCE OF RELATED APPLICATION

The present application claims priority under 35 U.S.C. 119(a-d) to CN 202010342497.0, filed Apr. 27, 2020.

### BACKGROUND OF THE PRESENT INVENTION

### Field of Invention

The present invention relates to the field of active optical rotators, and more particularly to an active optical rotator and an optical system for a Liquid Crystal Display (LCD) projector.

### Description of Related Arts

For a long time, the efficiency of the optical system of a single LCD projector is very low. In recent years, some low-cost technologies of PCS (Polarization Conversion System) have been continuously developed to improve the efficiency of the optical system, but the effect is not satisfying.

A major problem is that the conventional PCS device of a single LCD projector uses a wave plate and technical method to rotate the useless polarized light instead of that in a 3LCD projector, where natural light passing through the PBS (polarized light separation device) prism like the 3LCD projector. Separate the transmission of P light and the reflection of S light. The S light passes through the half-wave plate without changing the polarization state to achieve a perfect polarization plane rotation of 90°. For low-cost requirements, the PCS device of a single LCD projector usually requires light to go back and forth through the same ¼ wave plate to achieve optical rotation. These various quarter-wave plates are usually relatively cheap wave plates made by Japanese Teijin and other brands based on plastic materials, which have shortcomings of high light absorption rate, high heat generation, large dispersion, moisture absorption, and small aperture angle. Compared with wave plates, retarders, and depolarizers made of optical crystal glass, the gap in optical rotation performance is very large. However, the high price of wave plates causes a result that optical crystal is difficult to be applied in the single LCD projector industry.

Even the above-mentioned cheap quarter-wave plate, its price is still relatively high compared to the ecological characteristics of the single LCD projection industry, and most products cannot be used at all.

Therefore, it is necessary to solve the performance problem that the prior art cannot achieve high-quality and high-efficiency optical rotation, but also to find a new breakthrough in cost. This is the problem to be solved by the active optical rotator of the present invention; meanwhile, it is necessary to carry out comprehensive and scientific innovations to the existing deflection technology of single LCD projectors to truly improve the efficiency of the optical system. This is also the problem to be solved by the present invention.

### SUMMARY OF THE PRESENT INVENTION

In order to solve the above technical problems, an object of the present invention is to provide an active optical rotator with simple structure, low price, easy to manufacture, and favorable for realizing high efficiency and high quality optical rotation.

Technical solutions provided by the present invention are as follows. An active optical rotator, comprising a first glass substrate, a liner frame, a liquid crystal cell, a second glass substrate, and a first connecting wire and a second connecting wire;

wherein at least one light-transmitting window is provided on the liner frame;

the liner frame is interposed between an exit surface of the first glass substrate and an incident surface of the second glass substrate, and are mounted by surface, and then the liquid crystal cell is provided in the light-transmitting window;

a first transparent conductive film is provided on the exit surface of the first glass substrate, and a first alignment film is provided on the first transparent conductive film; the first connecting wire is connected with the first transparent conductive film;

a second transparent conductive film is provided on the incident surface of the second glass substrate, and a second alignment film is provided on the second transparent conductive film; the second connecting wire is connected with the second transparent conductive film;

the first transparent conductive film, the first alignment film, the liquid crystal cell, the second alignment film and the second transparent conductive film are sequentially arranged according to a light traveling direction.

Furthermore, the liner frame is directly provided on an edge of the exit surface of the first glass substrate;

or the liner frame is directly provided on an edge of the incident surface of the second glass substrate.

Preferably, the liquid crystal of the liquid crystal cell is made of materials with a temperature resistance of ≥75° C., but not limited to ≥75° C.

Furthermore, the active optical rotator, further comprises a driving device, wherein the driving device comprises a voltage source; the first connecting wire and the second connecting wire are connected to the voltage source.

Furthermore, the driving device further comprises a temperature compensation circuit for controlling an output voltage of the voltage source.

Preferably, the temperature compensation circuit comprises at least one temperature sensor located at the edge of the first glass substrate or the second glass substrate, and the temperature compensation circuit of the driving device collects the parameters of the temperature sensor and adjusts the output voltage of the voltage source, so as to keep the active optical rotator always in an efficient and high-quality optical rotatory state.

The present invention further provides an optical system for an LCD projector, comprising an LED light source, a transflective plate, a square cone condenser, a collimating lens, an active optical rotator as recited in any of the claims 1-4, a brightness enhancement polarizer, an LCD light valve, field lens, a reflector and projection lens;

wherein a light-transmitting portion that allows light to pass through is provided on the transflective plate; a size and an area of the light-transmitting portion are greater than or equal to that of a light-emitting surface of the LED light source; a reflection part that reflects light is provided on the exit surface of the transflective plate;

the light emitting surface of the LED light source faces the light transmitting portion (121);

an external dimension of the reflecting portion is greater than or equal to the dimension of the light-passing hole at the incident end of the square cone-shaped condenser.

Furthermore, the exit surface of the transflective plate and the incident end of the square cone-shaped condenser are attached to each other;

or the light-transmitting part and the reflecting part of the transflective plate are provided on the incident end of the square conical condenser;

or the incident surface of the transflective plate and the substrate of the LED light source are attached to each other.

Furthermore, the brightness-enhancing polarizer and the exit surface of the active optical rotator are attached to each other.

The beneficial effects of the present invention are as follows.

1. The active optical rotator of the present invention can achieve a relatively arbitrary optical rotation angle matching, and only needs to adjust the voltage of the driving device, or it can be replaced with a liquid crystal cell with different characteristics.

2. The active optical rotator of the present invention still has a relatively accurate optical rotation effect in a longer wavelength range under the irradiation of a larger light aperture angle, which is an advantage that those relatively inexpensive wave plates do not have.

3. The active optical rotator of the present invention can be fully automated through the production line of liquid crystal screens, has simple production and low cost, and is particularly suitable for mass production.

4. The transmittance of the active optical rotator of the present invention is much higher than those of relatively cheap wave plates based on plastic materials on the market, so the self-heating is lower and it is beneficial to obtain a longer service life.

5. The present invention uses an active optical rotator to rotate the polarized light that is useless to the LCD light valve separated by the brightness-enhancing polarizer twice in succession, so that the polarization plane or polarization is changed, and the polarization conversion is completed, and This part of the light is reflected by the transflective plate and the LED light source set at the incident end of the square cone condenser, and the light show will not overflow, so the light utilization rate of the projector is greatly improved and the power consumption is saved.

### BRIEF DESCRIPTION OF THE DRAWINGS

In order to explain the embodiments of the present invention or the technical solutions in the prior art more clearly, the following will briefly introduce the drawings that need to be used in the description of the embodiments or the prior art. Obviously, the drawings in the following description are only some of the embodiments described in the present invention. For those of ordinary skill in the art, other drawings can be obtained from these drawings without creative work.

FIG. 1 is a schematic diagram of the structure of an active optical rotator of the present invention;

FIG. 2 is a schematic structural diagram of an optical system for a projector of the present invention.

### DETAILED DESCRIPTION OF THE PREFERRED EMBODIMENT

In order to enable those skilled in the art to better understand the technical solutions of the present invention, the present invention will be described in detail below with reference to the accompanying drawings. The description in this section is only exemplary and explanatory, and should not have any limitation on the protection scope of the present invention.

It should be noted that similar reference numerals and letters indicate similar items in the following drawings. Therefore, once an item is defined in one drawing, it does not need to be further defined and explained in the subsequent drawings.

It should be noted that the terms “center”, “upper”, “lower”, “left”, “right”, “vertical”, “horizontal”, “inner”, “outer”, etc. indicate the orientation or positional relationship: Based on the orientation or position relationship shown in the drawings, or the orientation or position relationship usually placed when the product of the invention is used, it is only for the convenience of describing the present invention and simplifying the description, and does not indicate or imply that the device or element referred to must It has a specific orientation, is constructed and operated in a specific orientation, and therefore cannot be understood as a limitation to the present invention. In addition, the terms “first”, “second”, “third”, etc. are only used for distinguishing description, and cannot be understood as indicating or implying relative importance.

In addition, the terms “horizontal”, “vertical”, “overhanging” and other terms do not mean that the component is required to be absolutely horizontal or overhanging, but may be slightly inclined. For example, “horizontal” only means that its direction is more horizontal than “vertical”, it does not mean that the structure must be completely horizontal, but can be slightly inclined.

In the description of the present invention, it should also be noted that the terms “set”, “installation”, “connected”, and “connected” should be interpreted broadly, unless clearly defined and defined otherwise. For example, they may be fixed connections. It may also be detachably connected or integrally connected; it may be mechanically connected or electrically connected; it may be directly connected or indirectly connected through an intermediate medium, and it may be the internal communication between two components. For those of ordinary skill in the art, the specific meaning of the above-mentioned terms in the present invention can be understood in specific situations.

### Embodiment 1

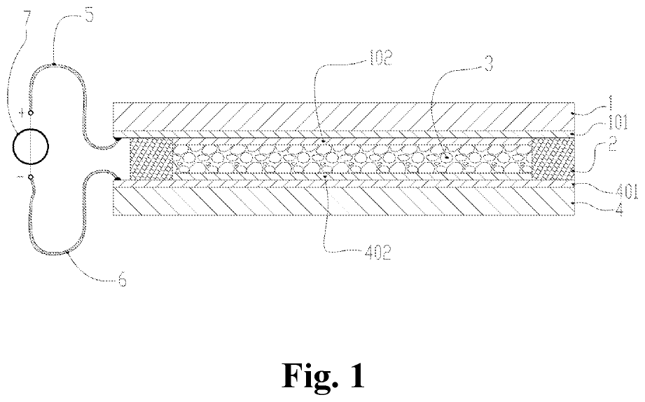

As shown in FIG. 1, the active optical rotator provided by this embodiment comprises: a first glass substrate 1, a spacer frame 2, a liquid crystal cell 3, a second glass substrate 4, a first connection line 5, and a second connection wire 6.

A first transparent conductive film 101 and a first alignment film 102 are fabricated on an exit surface of the first glass substrate 1; an opposite end of the first connecting wire 5 is connected to the first transparent conductive film 101, and the other end is connected to a positive electrode of the driving device 7.

A second transparent conductive film 401 and a second alignment film 402 are fabricated on an incident surface of the second glass substrate 4; an opposite end of the second connecting wire 6 is connected to the second transparent conductive film 401, and the other end is connected to a negative electrode of the driving device 7.

A light-transmitting window is opened a middle portion of the gasket frame 2 for setting the liquid crystal cell 3.

A gasket frame 2 is interposed between the exit surface of the first glass substrate 1 and the entrance surface of the second glass substrate 4, and then sealed and bonded; the liquid crystal cell 3 is arranged in the light-transmitting window.

According to the thickness of the liquid crystal cell 3 (that is, the thickness of the spacer frame 2), the type of liquid crystal, and the optical rotation angle required by the optical system, the output voltage of the driving device 7 is adjusted. The first transparent conductive film 101 and the second transparent conductive film under the action of the electric field force generated by 401, the liquid crystal molecules of the liquid crystal cell 3 rotate to a desired angle.

When linearly polarized light passes through the active optical rotator described in FIG. 1, it will rotate the corresponding polarization plane according to the rotation angle of the liquid crystal molecules to achieve the function of light rotation; or change the polarization state according to the characteristics of the liquid crystal molecules, So as to realize the optical rotation function, and finally enable the LCD projector optical system with PCS function to realize more efficient and higher quality polarization conversion function.

Since the optical rotation characteristics of liquid crystals are affected by temperature, a temperature sensor (not shown in the figure) is installed on the edge of the first glass substrate 1 or the second glass substrate 4 where light is not blocked, and the signal of the temperature sensor It is sent to the driving device 7, and the output voltage is adjusted through the temperature compensation circuit of the driving device 7, so that the active optical rotator always works in the most accurate optical rotation performance state, thereby maintaining the highest optical rotation efficiency and optical rotation quality.

### Embodiment 2

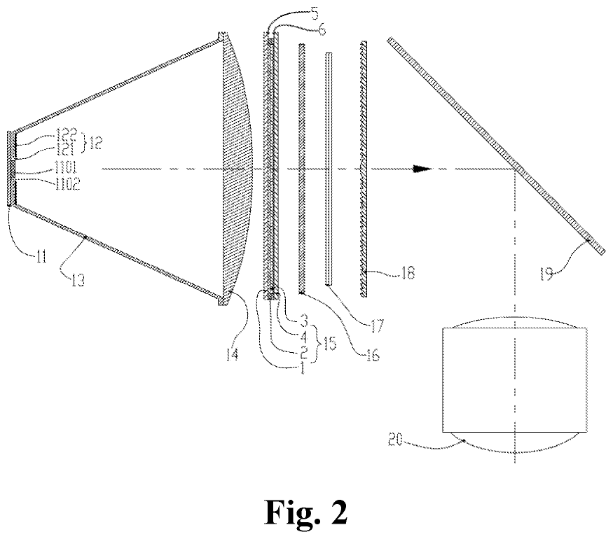

As shown in FIG. 2, the LCD projector optical system provided by this embodiment comprises an LED light source 11, a transflective plate 12, and a square cone condenser, also called a V-shaped light funnel, arranged in sequence according to the direction of light travel. 13. The collimating lens 14, the active optical rotator 15, the brightness-enhancing polarizer 16, the LCD light valve 17, the field lens 18, the reflecting mirror 19, and the projection lens 20 in the first embodiment.

The transflective plate 12 is preferably fabricated on the incident port of the square cone condenser 13, and the gap between the window of the light-transmitting portion 121 and the light-emitting surface 1101 is preferably 0.05-0.12 mm on one side; The light-emitting surface 1101 of the LED light source 1 is embedded in the light-transmitting part 121.

The light spread of the incident end of the square cone condenser 13 is equal to the light spread of the LCD light valve 17 under the restriction of the projection lens 20.

The collimating lens 14 is a free-form surface lens, a Philippine lens or the like. The basic design essentials is to separate and reflect as much of the polarized light as possible by the brightness-enhancing polarizer 16 and converge it at the incident port of the square cone concentrator 13 and pass through the reflecting part 122, The light-emitting surface 1101 and the substrate 1102 of the LED light source 11 located in the light-transmitting part 121 are reflected back, so as to be used by the projection lens 20.

The light emitted from the LED light source 11 in this embodiment sequentially passes through the light-transmitting portion 121 on the transflective plate 12, the square cone condenser 13, the collimating lens 14, and the active optical rotator 15 before reaching the brightness-enhancing polarizer 16; The brightness-enhancing polarizer 16 separates the incident light into polarized light, and separates two polarized lights that are useful and useless for the LCD light valve 17. The two polarized lights are linearly polarized light with equal amplitude and orthogonal vibration; for the LCD light valve 17 A useful way of polarized light passes through the LCD light valve 17, and then is projected out through the field lens 18, the mirror 19 and the projection lens 20 in turn; the useful way of polarized light that is useless to the LCD light valve 17 is reflected back and passes through the active optical rotation After the reflector 15, the collimating lens 14 and the square cone condenser 13 reach the reflecting part 122 and the light transmitting part 121 of the transflective plate 12, after being reflected by the reflecting part 122 and the LED light source 11 opposite to the light transmitting part 121, After passing through the square cone condenser 13, the collimating lens 14, and the active rotator 15 in turn, it reaches the brightness-enhancing polarizer 16, during which it passes through the active rotator 15 twice in succession, and then the polarization plane or polarization changes, and then It can pass through the brightness-enhancing polarizer 16 to become the polarized light that can be used for the LCD light valve 17 to complete the polarization conversion process, and this part of the light is provided by the transflective plate 12 and the LED at the incident end of the square cone condenser 13 The light source 11 is reflected, and the light show will not overflow, so the light utilization rate of the projector is greatly improved and the power consumption is saved.

By adjusting the output voltage of the driving device of the active optical rotator 15, the highest brightness output by the projector is the voltage value. Generally speaking, if the active rotator 15 in FIG. 2 is not installed, the projector output brightness is 200 lumens, and the area of the light-emitting surface 1101 of the LED light source 11 is equal to that of the square cone condenser 13 When the area ratio of the light-passing hole at the incident end is 45%-50%, and the reflectivity of the reflecting part 122 is ≥98%, the active optical rotator 15 is set and the driving voltage is adjusted, and the projector can Easily output about 300 lumens; when the active rotator 15 is replaced with those relatively inexpensive quarter-wave plates based on plastic materials, the projector can only output 220-250 lumens, and the image will appear more serious Therefore, the efficiency of the active optical rotator 15 of the present invention is greatly improved, and the input cost is lower than those of relatively inexpensive quarter-wave plates based on plastic materials.

It should be noted that in this article, the terms “including”, “including” or any other variants thereof are intended to cover non-exclusive inclusion, so that a process, method, article or device including a series of elements not only includes those elements, It also includes other elements not explicitly listed, or elements inherent to the process, method, article, or equipment.

Specific examples are used in this article to illustrate the principle and implementation of the present invention. The description of the above examples is only used to help understand the method and core idea of the present invention. The above are only the preferred embodiments of the present invention. It should be pointed out that due to the limited expression of words, there are objectively unlimited specific structures. For those of ordinary skill in the art, without departing from the principle of the present invention, Several improvements, modifications or changes can also be made, and the above technical features can also be combined in an appropriate manner; these improvements, modifications or combinations, or the concept and technical solution of the invention are directly applied to other occasions without improvement, All should be regarded as the protection scope of the present invention.

1-7. (canceled)

8: An active optical rotator, comprising a first glass substrate (1), a liner frame (2), a liquid crystal cell (3), a second glass substrate (4), and a first connecting wire (5) and a second connecting wire (6);
wherein at least one light-transmitting window is provided on the liner frame (2);
the liner frame (2) is interposed between an exit surface of the first glass substrate (1) and an incident surface of the second glass substrate (4), and are mounted by surface, and then the liquid crystal cell (3) is provided in the light-transmitting window;
a first transparent conductive film (101) is provided on the exit surface of the first glass substrate (1), and a first alignment film (102) is provided on the first transparent conductive film (101); the first connecting wire (5) is connected with the first transparent conductive film (101);
a second transparent conductive film (401) is provided on the incident surface of the second glass substrate (4), and a second alignment film (402) is provided on the second transparent conductive film (401); the second connecting wire (6) is connected with the second transparent conductive film (401); and
the first transparent conductive film (101), the first alignment film (102), the liquid crystal cell (3), the second alignment film (402) and the second transparent conductive film (401) are sequentially arranged according to a light traveling direction.

9: The active optical rotator, as recited in claim 8, wherein the liner frame (2) is directly provided on an edge of the exit surface of the first glass substrate (1).

10: The active optical rotator, as recited in claim 8, wherein the liner frame (2) is directly provided on an edge of the incident surface of the second glass substrate (4).

11: The active optical rotator, as recited in claim 8, further comprising a driving device (7), wherein the driving device (7) comprises a voltage source; the first connecting wire (5) and the second connecting wire (6) are connected to the voltage source.

12: The active optical rotator, as recited in claim 11, wherein the driving device (7) further comprising a temperature compensation circuit for controlling an output voltage of the voltage source.

13: An optical system for an LCD projector, comprising an LED light source (11), a transflective plate (12), a square cone condenser (13), a collimating lens (14), the active optical rotator (15) as recited in claim 8, a brightness enhancement polarizer (16), an LCD light valve (17), field lens (18), a reflector (19) and projection lens (20);
wherein a light-transmitting portion (121) that allows light to pass through is provided on the transflective plate (12); a size and an area of the light-transmitting portion (121) are greater than or equal to that of a light-emitting surface (1101) of the LEI) light source (11); a reflection part (122) that reflects light is provided on the exit surface of the transflective plate (12);
the light emitting surface (1101) of the LED light source (1) faces the light transmitting portion (121);
an external dimension of the reflecting portion (122) is greater than or equal to the dimension of the light-passing hole at the incident end of the square cone-shaped condenser (13).

14: The optical system for an LCD projector, as recited in claim 13, wherein the exit surface of the transflective plate (12) and the incident end of the square cone-shaped condenser (13) are attached to each other;

15: The optical system for an LCD projector, as recited in claim 13, wherein the light-transmitting part (121) and the reflecting part (122) of the transflective plate (12) are provided on the incident end of the square conical condenser (13).

16: The optical system for an LCD projector, as recited in claim 13, wherein the incident surface of the transflective plate (12) and the substrate (1102) of the LED light source (11) are attached to each other.

17: The optical system for an LCD projector, as recited in claim 13, wherein a brightness-enhancing polarizer (16) and the exit surface of the active optical rotator (15) are attached to each other.
